(19) United States
(12) Patent Application Publication
(10) Pub. No.: US 2026/0268210 A1
(43) Pub. Date: Sep. 10, 2026

(54) ETHICAL ARTIFICIAL INTELLIGENCE DECISION MAKING SYSTEM

(71) Applicant: Dhaval Mahesh Chawda, Chatham, GA (US)

(72) Inventor: Dhaval Mahesh Chawda, Chatham, GA (US)

(21) Appl. No.: 19/074,368

(22) Filed: Mar. 8, 2025

(51) Int. Cl. G06N 20/00

(52) U.S. Cl. CPC G06N 20/00

(57) ABSTRACT

An ethical artificial intelligence (AI) decision making system integrates an automated framework and system for evaluating, modifying, and auditing AI generated decisions in real-time. The system processes input data through an AI model that generates an initial decision, which is then analyzed by an ethical processing layer using predefined ethical constraints derived from a human-centered decision making ethical workshop within a multi-level AI governance framework. If discrepancies or violations are detected, the system adjusts the decision before finalizing the output. An audit and logging mechanism records decision parameters, ethical evaluations, and modifications to ensure transparency and compliance. A feedback loop dynamically and continuously refines AI model parameters based on stakeholder input enhancing fairness and accountability over time.

### CROSS-REFERENCE TO RELATED APPLICATIONS

N/A

### BACKGROUND OF THE INVENTION

### 1. Field of the Invention

The present invention generally relates to artificial intelligence models but more particularly to an ethical artificial intelligence decision making system.

### 2. Description of Related Art

Artificial intelligence (AI) is increasingly being integrated into a wide range of industries, including finance, healthcare, human resources, law enforcement, and autonomous systems. AI decision making enhances efficiency, automation, and data driven insights, reducing the reliance on human intervention for complex tasks. However, the widespread adoption of AI has introduced several ethical, legal, and transparency challenges that limit trust and acceptance.

While AI has demonstrated its potential in transforming industries, several critical shortcomings exist in the deployment of AI based decision making systems, including but not limited to, a lack of ethical oversight, lack of transparency, bias in AI predictions based on training datasets, compliance challenges, inconsistent stakeholder involvement without multi-level engagement, and a lack of real-time ethical adaptation.

There has been an attempt to introduce ethical considerations into AI, such as governmental AI ethical principles and guidelines. However, there is a lack of enforceability and real-time integration into AI-systems. Explainable AI (XAI) approaches have been introduced to make AI more transparent, however, these models only attempt to explain AI decisions and do not ensure AI is inherently ethical, fair, or compliant. Consequently, a solution is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide proactive AI ethics enforcement to ensure fair, transparent, and explainable AI decision making in real time.

It is another object of the present invention to provide a multi-level ethical AI governance providing communication and transparency across all levels.

It is yet another object of the present invention to provide an ethical decision making pipeline to ensure ethical principles, bias detection mechanisms, and compliance rules are applied before finalizing ai generated outputs.

It is another object of the present invention to provide real-time AI ethics adaptation to provide continuously updated AI ethical principles based on stakeholder feedback and understanding, business landscapes and understanding, and real word AI interactions.

It is yet another object of the present invention to provide transparency, accountability and trust for AI generated outputs.

In order to do this, a computer-implemented method for ethical decision-making in an AI system is provided, comprising receiving input data relevant to an AI-driven decision; generating a preliminary decision output by processing the input data with a trained AI model executed by at least one processor; applying an ethical processing layer to the preliminary decision output by executing a set of programmed instructions that incorporate predefined ethical constraints from an ethical constraints database, wherein the ethical processing layer automatically analyzes the preliminary decision against the ethical constraints and modifies the decision when a violation of an ethical rule is detected; and producing a final decision output that complies with the ethical constraints, the final decision output being provided to a user or another system, wherein the method further comprises logging data describing the ethical analysis of the decision in an audit record and initiating a notification if the preliminary decision required modification, such that the AI system's decisions are both ethically vetted and transparently recorded in real-time.

In one embodiment, the ethical constraints database comprises a structured datastore of machine-readable rules and parameters defining permissible decision criteria, and wherein the step of applying the ethical processing layer includes retrieving one or more relevant ethical rules from the database based on a context of the input data or the type of decision, and using the retrieved rules to determine whether the preliminary decision output satisfies all applicable constraints.

In another embodiment, the method is configured to automatically adjusting at least one parameter of the AI model based on feedback, wherein after producing the final decision output, the system receives stakeholder feedback or an override input indicating a degree of ethical satisfaction with the decision, and in response, updates the AI model's parameters or retrains the AI model to improve future decision outputs, thereby providing a feedback loop that dynamically improves the AI model's adherence to the ethical constraints over time.

In one embodiment, applying the ethical processing layer includes executing a decision analysis module that computes one or more quantitative ethics metrics for the preliminary decision output, including bias measures or risk scores, and if any metric exceeds a predefined threshold from the ethical constraints database, the decision analysis module triggers an ethical review sub-routine that alters the preliminary decision output to generate the final decision output, the alteration comprising adjusting the ethical constraints database such that the one or more quantitative ethics metrics are brought within acceptable limits.

In another embodiment, the method further comprises a training phase for the AI model in which training data is filtered or re-weighted based on ethical parameters prior to generating the preliminary decision output; and training the AI model on a dataset that has been processed according to the ethical constraints by identifying under-represented categories or potentially biased features in the dataset and augmenting the training data with respect to those ethical parameters, thereby reducing bias in the model's predictions and enhancing compliance with the ethical constraints from the outset of model development.

In yet another embodiment, the audit record is stored in a secure, tamper-evident log and includes information about the preliminary decision, the specific ethical constraint(s) that were applied, any modification made, and an identifier for the version of the ethical constraints database used, thereby facilitating later compliance verification and debugging of the AI system's decision process.

The foregoing has outlined rather broadly the more pertinent and important features of the present disclosure so that the detailed description of the invention that follows may be better understood and so that the present contribution to the art can be more fully appreciated.

Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a diagram illustrating a multi-level ethical AI governance process for the ethical artificial intelligence decision making system according to an embodiment of the present invention.

FIG. 2 is a flow diagram illustrating an ethical framework for the ethical artificial intelligence decision making system according to an embodiment of the present invention.

FIG. 3 is a diagram for the environ landscape for the ethical artificial intelligence decision making system according to an embodiment of the present invention.

FIG. 4 is the ethical prism for the ethical artificial intelligence decision making system according to an embodiment of the present invention.

FIG. 5 is a flow diagram for the edify process for the ethical artificial intelligence decision making system according to an embodiment of the present invention.

FIG. 6 is a flow diagram for the evolve process which includes a weighted ethics and context process for each team in the multi-level ethical AI governance system according to an embodiment of the present invention.

FIG. 7 is an AI model data architectural diagram for the ethical artificial intelligence decision making system according to an embodiment of the present invention.

FIGS. 8A-B illustrates a flow diagram for the ethical artificial intelligence decision making system according to an embodiment of the present invention.

FIG. 9 is a flow diagram illustrating the AI workflow and ethical processing layer according to an embodiment of the present invention.

FIG. 10 is a flow diagram illustrating the ethical artificial intelligence decision making pipeline according to an embodiment of the present invention.

FIG. 11 illustrates an AI ethics feedback loop for the ethical artificial intelligence decision making system according to an embodiment of the present invention.

FIG. 12 illustrates a computerized hardware environment for the ethical artificial intelligence decision making system according to an embodiment of the present invention.

### DETAILED DESCRIPTION OF THE INVENTION

The following description is provided to enable any person skilled in the art to make and use the invention and sets forth the best modes contemplated by the inventor of carrying out this invention. Various modifications, however, will remain readily apparent to those skilled in the art, since the general principles of the present invention have been defined herein to specifically provide an ethical artificial intelligence decision making system.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

The present invention describes an ethical artificial intelligence decision making system, which provides a structured methodology for integrating, monitoring, and refining ethical decision-making within AI models. The system is designed to be scalable, adaptable, and transparent, ensuring AI-generated decisions are inclusive, fair, and aligned with human-centered values.

The system uses an AI model (neural network) for initial prediction, then a ethical processing layer (rule-based engine) which executes on a computing device to modify or validate the prediction based on a set of stored rules in an ethical constraints database, followed by an update step that retrains the neural network parameters if needed.

The ethical AI decision making system is a multi-layered system designed to evaluate and adjust AI generated decisions in real-time based on predefined ethical principles, transparency mechanisms, and compliance constraints. The system enables proactive bias detection, real-time ethical decision adjustments, and explainable AI outputs, ensuring AI-driven decisions are traceable, auditable, and aligned with stakeholder expectations. More specifically, the system integrates a bias detection module, which processes AI-generated decisions through a computational fairness analysis process, which applies predefined ethical thresholds stored in an ethical constraints database, dynamically adjusting AI output weighting to ensure compliance.

In one embodiment, the AI system includes an AI framework which comprises of four primary value pillars that define its implementation within AI systems:
Integrity—AI decision making is embedded with strong moral foundations to foster inclusive and equitable collaboration between AI systems and stakeholders.
Transparency—AI models operate within a structured, auditable framework that enables continuous monitoring, updates, explainability, and stakeholder approvals in real-time.
Awareness—Stakeholders receive training and insights on AI ethics to limit bias and improve AI fairness.
Empathy—AI decision making processes prioritize human-centered interactions and emotions, ensuring knowledgeable and compassionate responses aligned with ethical considerations.

To implement these value pillars effectively, the invention includes specific system drivers and enablers, as described in the subsequent disclosure herein. In one embodiment, the ethical artificial intelligence decision making system is implemented as a network of computing devices executing specialized AI software components. These components include: a trained AI model that generates preliminary decisions in response to input data, an ethical processing layer that evaluates and modifies the preliminary decisions, an ethical constraints database storing machine-readable ethical rules, and an audit and compliance subsystem that logs system outputs and verifies ongoing adherence to the ethical principles. By distributing these modules across one or more servers or computing nodes, the system can scale to handle high-throughput AI decision making with real-time ethical vetting.

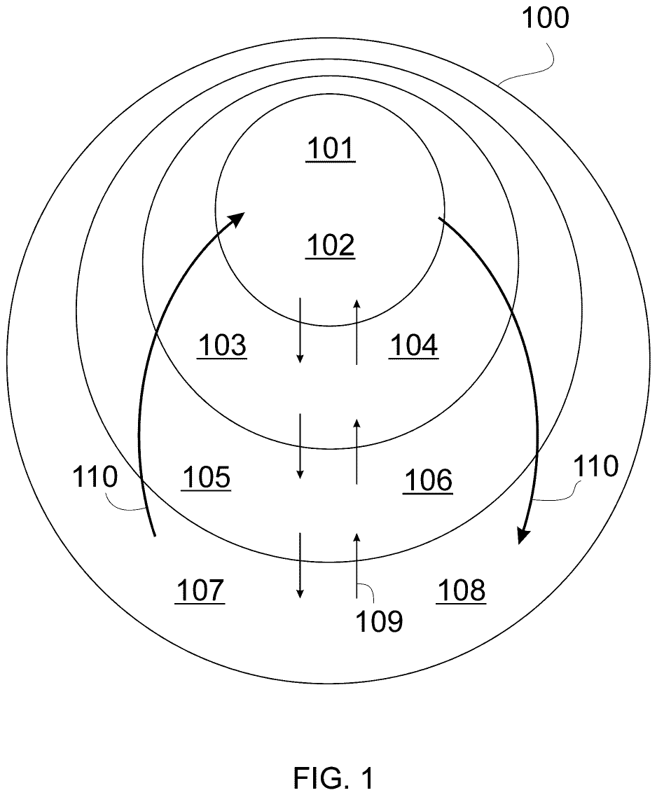

FIG. 1 is a diagram illustrating a multi-level ethical AI governance process for the ethical artificial intelligence decision making system according to an embodiment of the present invention. Referring now to FIG. 1, the multi-level ethical AI governance process 100 is illustrated, comprising in one embodiment, a managing director 101, C-Suite executives 102, a principle 103, project leaders 104, seniors 105, consultants 106, associates 107, and juniors 108. Any person or team in the hierarchy may be defined as a “user” herein. Which may include users across all levels. Advantageously, the process involves communication 109 among all corporate levels, wherein the AI system 110 is not centralized in any one demographic or organizational level, ensuring that ethical AI governance is distributed and transparent across all levels. It should be understood that the process may extend to end-users, developers, compliance officers, etc. depending on the system's goals, exposure, purpose, or application.

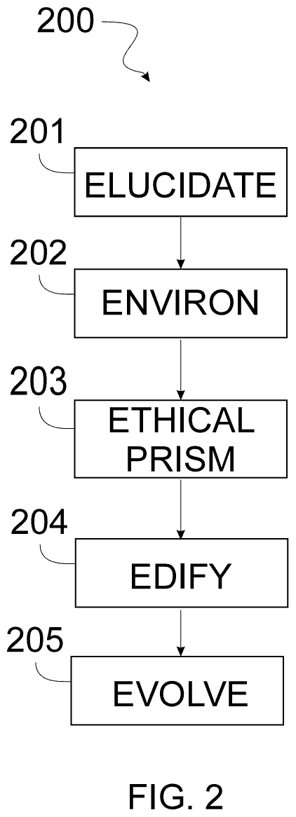

FIG. 2 is a flow diagram illustrating an ethical framework for the ethical artificial intelligence decision making system according to an embodiment of the present invention. In one embodiment, the ethical framework 200 comprises elucidate 201, environ 202, ethical prism 203, edify 204, and evolve 205. The framework and decision making process of the AI system will be discussed in more details below, however, briefly elucidate 201 includes defining a problem and developing a clear AI prompt. Environ 202 includes understanding the context of the prompt. Ethical prism 203 includes brainstorming and development including weighted decision matrices and scoring models. Edify 204 includes evaluating and examining ethics with context. Evolve 205 includes setting parameters of ethics and context at different levels.

In one embodiment, elucidate 201 comprises questions to provide clarity to the problem to provide a clear AI prompt, wherein the questions include the fundamental questions for understanding, specifically, who: a specific user or user group of users, what: specific user enablement, wow: specific and differentiating value to the user (without prescribing “how”), and why: specific measurable reason for executing the vision statement. The elucidation process is intended to be collaborative within the ethical framework, which helps frame the problem in the “who, what, wow, and why” format.

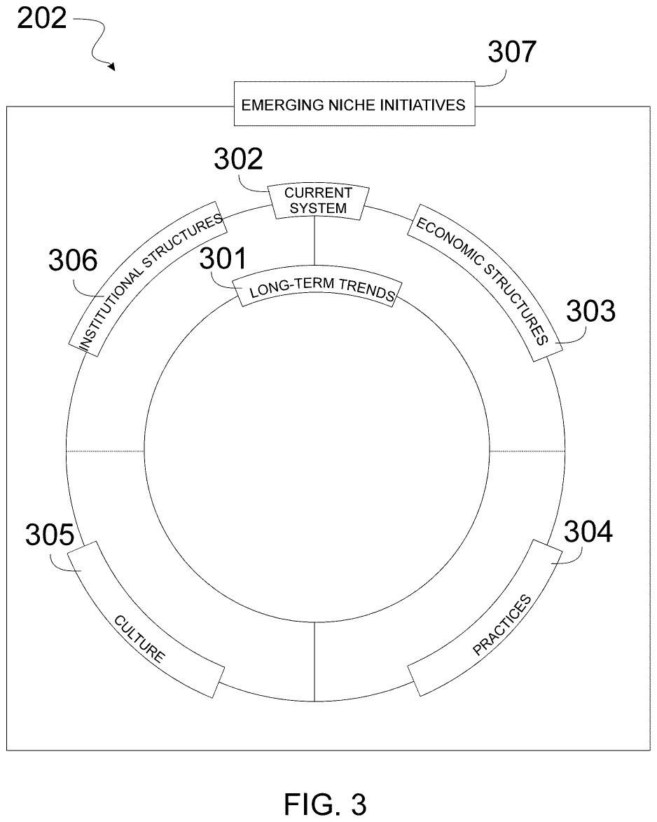

FIG. 3 is a diagram for the environ landscape for the ethical artificial intelligence decision making system according to an embodiment of the present invention. Referring now to FIG. 3, the environ 202 understanding landscape is illustrated. In one embodiment, the landscape illustrated is configured to be used as a template, to aid in the understanding of the context of the prompt, i.e. “big picture” by mapping the current practices, trends and innovative initiatives in the system. In the center of the template, a user should provide the long-term trends 301, wherein the long-term trends are trends affecting the problem/issue over the long term future. For example, climate change, population growth, aging, resources depletion, economic stability, etc. Next, the user is configured to map the current system 302, which includes economic structures 303 (market, financing consumption, production, and distribution), practices 304 (routines and behaviors), culture 305 (social norms and values), and institutional structures 306 (rules, regulations, and power structures). Finally, the user is configured to map the emerging niche initiatives 307 within the outer rectangle of the template, which includes mapping the alternative ways of doing (what are the new, innovative ways of dealing with the issue?), e.g. pilot programs, social innovation cases, new technology, start-ups applications, etc.

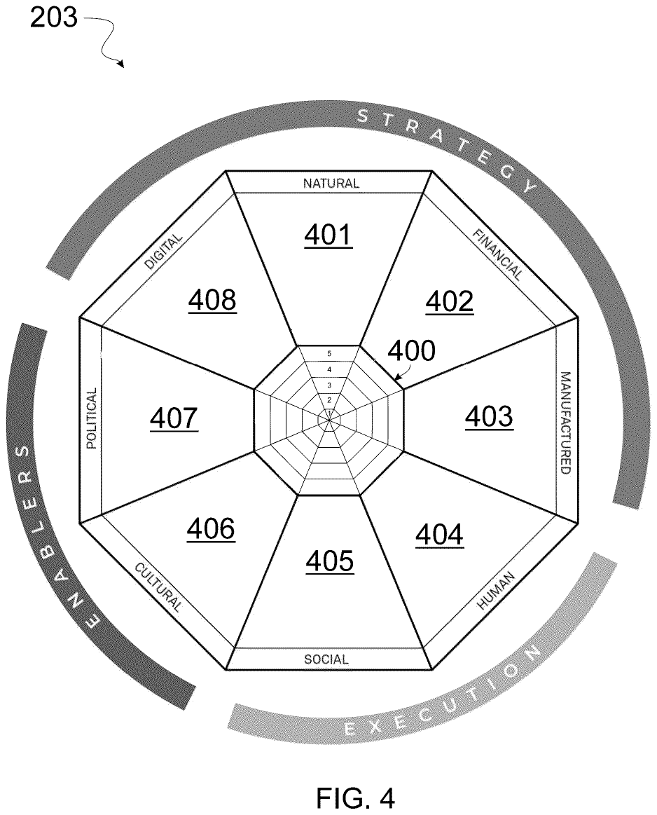

FIG. 4 is the ethical prism for the ethical artificial intelligence decision making system according to an embodiment of the present invention. Referring now to FIG. 4, the ethical prism 203 is illustrated. In one embodiment, the ethical prism is a template that helps the understanding of ethical considerations by mapping and scoring different parameters considered within the organization for the AI prompt. It is used by users throughout all levels in the multi-level system as previously discussed, to generate and brainstorm a shared understanding and about various parameters to generate a weighted decision matrix and scoring model 400. Specifically, in this process users from each level of the organization team (101-108; FIG. 1) would complete the template. The parameters may vary, however, in one embodiment, some parameters include, natural 401, financial 402, manufactured 403, human 404, social 405, cultural 406, political 407, and digital 408. Natural 401 includes such as natural resources, including renewable non-reneable resources, fauna, flora, and their life supporting systems. Financial 402 includes the productive power in the resources of the other types of capitals, and the resources and assets of an individual or entity in the form of a currency that can be accrued, owned, or traded. Manufactured 403 includes all material goods, human-made elements, including physical infrastructures, roads, machines and similar goods. Human 404 includes the ability and capability of individuals to produce and manage their well-being, such as health knowledge, skills, and motivation. Social 405 includes the professional and the social connections among humans, including partnership and collaborations, etc. Cultural 406 includes values and beliefs inherent in social practices, or incorporated by communities. Cultural 406 also includes ethnicity, spirituality, heritage, traditions, and daily practices. Political 407 includes structures in organizations that determine how decisions are made and power is distributed, which involves hierarchy, inclusion, equity, transparency, access, and participation. Digital 408 includes digital infrastructure and data, including digital platforms as well as the mechanisms of data collection, analysis, and storage. It should be understood that these descriptions are a guide or starting point for the brainstorming process, and should not be considered limiting. More specifically, the evaluated ethical parameters will act like a guide for stakeholders with respect to execute an AI prompt via the system. When integrated into the AI system as an ethical processing layer it improves the AI system's decision accuracy because it catches inconsistencies the unmodified AI system might miss, thereby reducing error rates, enabling ethical oversight in AI.

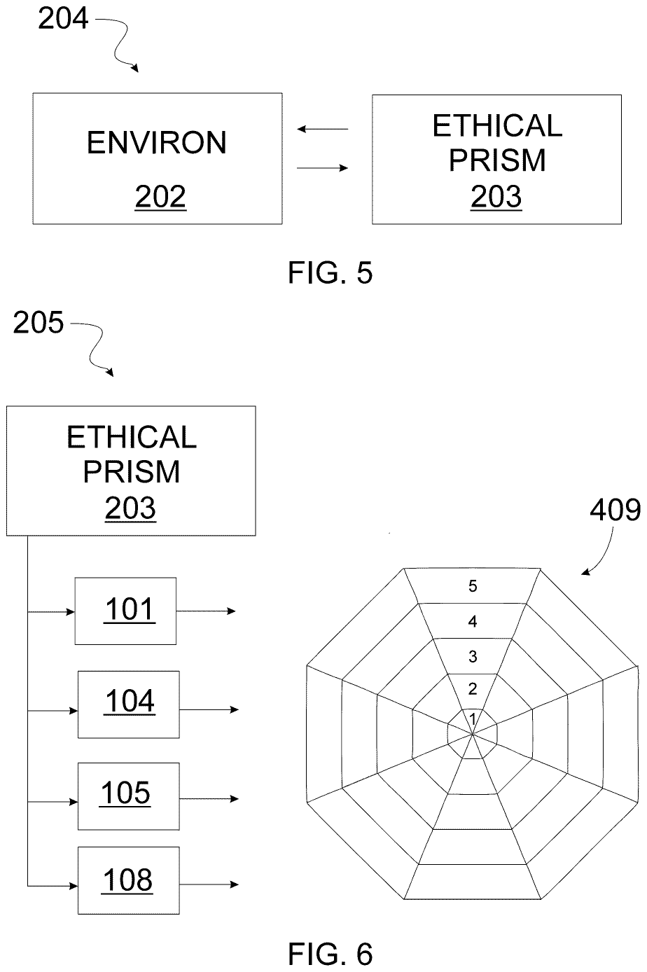

FIG. 5 is a flow diagram for the edify process for the ethical artificial intelligence decision making system according to an embodiment of the present invention. Referring now to FIG. 5, the edify process 204 is to evaluate and examine ethics with context. The environ template 202 is compared with the ethical prism 203 which is critical for aligning AI driven decision making with ethical standards, stakeholder roles, and real-world business environments. More specifically, this process involves analyzing the ethical processes and steps in earlier stages and comparing it to the real-world operational context in which the AI system is being deployed. The edify process 204 ensures that ethical principles are not applied in isolation, but rather in a manner relevant to the specific team, organizational function, and AI system use case. By doing so, it bridges the gap between abstract ethical guidelines and practical AI deployment, ensuring that AI decisions are fair, transparent, and aligned with organizational values.

FIG. 6 is a flow diagram for the evolve process which includes a weighted ethics and context process for each team in the multi-level ethical AI governance system according to an embodiment of the present invention. Referring now to FIG. 6, the evolve process receives evaluated ethical parameters from the edify process (FIG. 5). These parameters undergo quantitative scoring using decision-weighted matrices, ensuring that each organizational level receives AI outputs aligned with their specific ethical priorities. More specifically, the parameters of ethics and context at different levels (101 . . . 108) of the multi-level AI-governance system are defined. By comparing environ (202; FIG. 3) and ethical prism (203; FIG. 4) in the edify step (204; FIG. 5), an ideal set of parameters of ethics and context are defined with weighted decision matrices and scoring models 409 and importance of each sector, which then can be deployed in the AI models. Although one scoring model 409 is illustrated, it is understood that after the evolve process 205 a scoring model will be provided for each sector of the multi-level AI-governance system (101 . . . 108), i.e. at least one per sector or organizational level. The evolve process ensures iterative improvements when implemented and integrated into the AI system.

Advantageously, after deriving key insights and ethical parameters from the previous steps, these principles can be proactively integrated into AI models to ensure ethical and inclusive decision making. The deployment of these ethical parameters facilitates structured data distribution, enabling teams to interact with and refine AI systems in alignment with fairness, transparency, and accountability standards. By leveraging all components of the Ethical AI decision making system, stakeholders across various organizational levels and roles receive AI-generated outputs that have been evaluated, filtered, and tailored to align with their specific responsibilities, objectives, and ethical considerations. This ensures that AI driven decisions remain contextually relevant, inclusive, and ethically sound for all users involved in the decision making process.

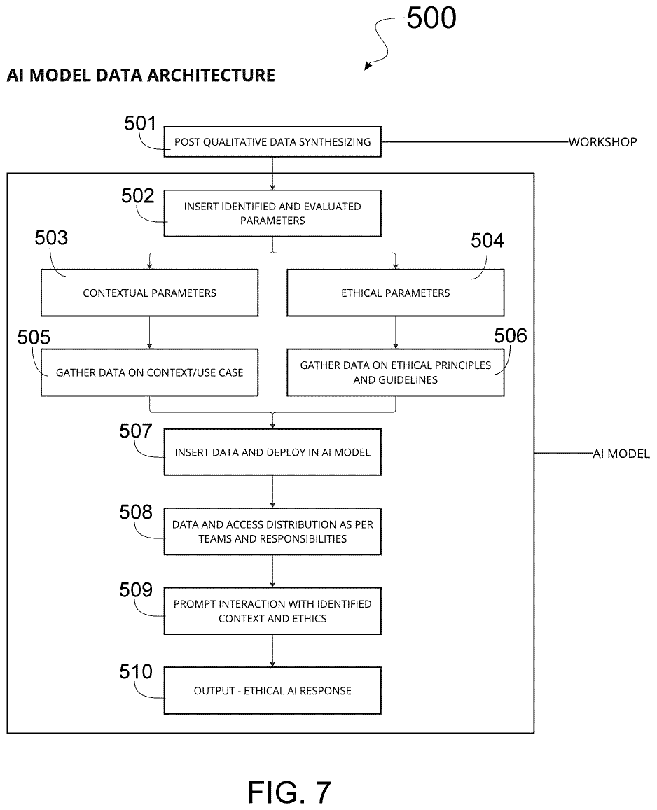

FIG. 7 is an AI model data architectural diagram for the ethical artificial intelligence decision making system according to an embodiment of the present invention. Referring now to FIG. 7, the AI model data architecture 500 is illustrated. In one embodiment, the AI model data architecture may be divided into a workshop and AI model, wherein the workshop is defined as the post qualitative data synthesizing 501, i.e. the process steps described above and shown in FIGS. 1-6. After the conclusion of the human-centered ethical AI workshops described above, in step 502, identified and evaluated parameters are inserted into the AI model, which include contextual parameters 503, ethical parameters 504, data gathered on context/user case 505, and data gathered on ethical principles and guidelines 506. In step 507, the data is inserted and deployed in the AI model. In 508, the data and access is distributed according to team roles and responsibilities. Next in 509, the prompt includes interaction with identified context and ethics. Finally, in step 510, the AI-output is provided comprising an ethical AI response.

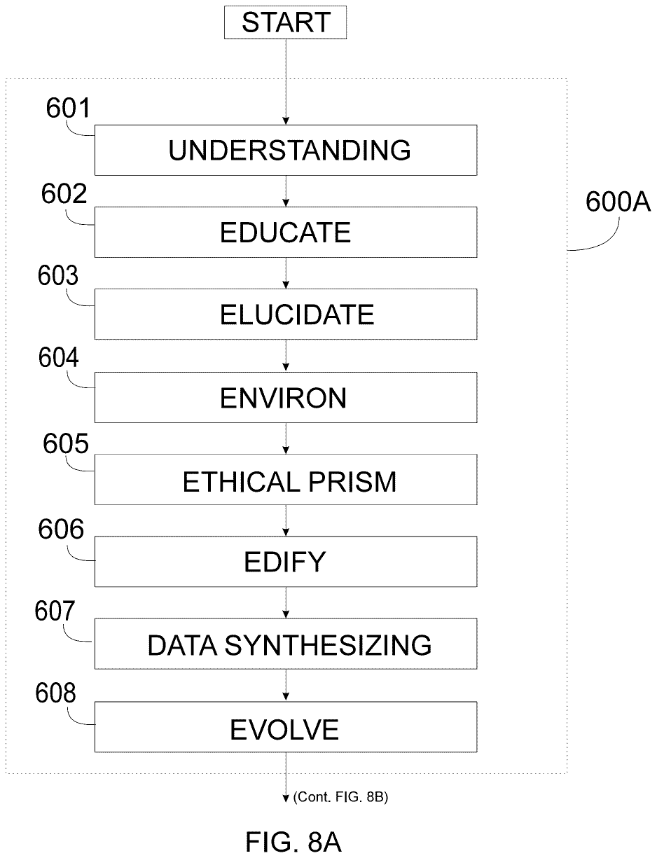

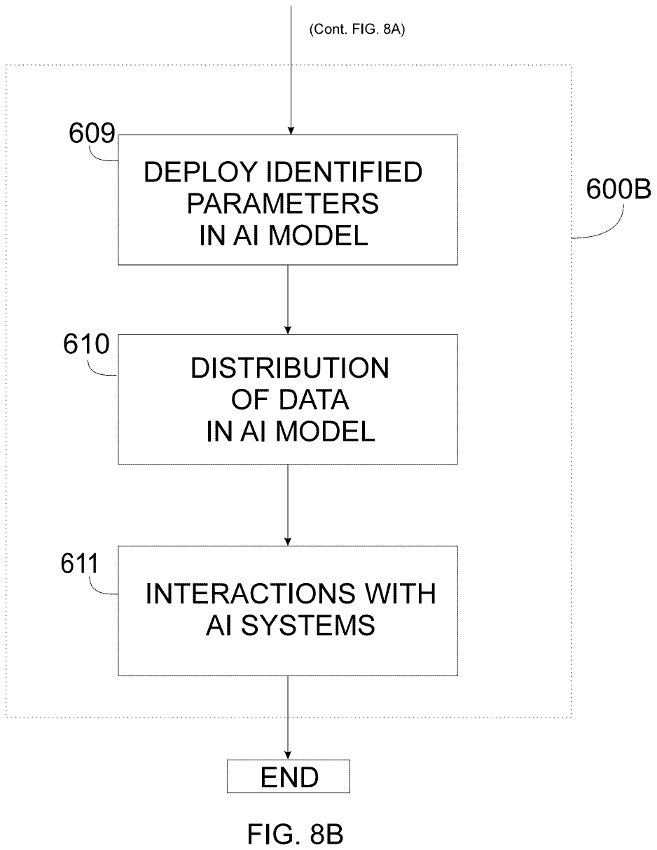

FIGS. 8A-B illustrates a flow diagram for the ethical artificial intelligence decision making system according to an embodiment of the present invention. Referring now to FIGS. 8A-B, the overview of the system is provided, within the human-centered flow 600A, and proactive AI system integration 600B. The details of the steps were previously described, but the order and flow is critical for understanding the process at a high level. In step 601, the workshop phase or the understanding of the stakeholders is carried out. Further, the understanding of the landscape of the business and problem is carried out. In step 602, the educate process is carried out, i.e. the AI-frame work of steps 603-606, elucidate, environ, ethical prism, and edify respectively. In step 607, data synthesizing processing for generating ethical parameters from the previous steps. Then, in step 608, evolve, the last part of the educate process is carried out, to evaluate parameters of context and ethics for different teams of the multi-level AI governance system. Next, after the human-centered workshop, the AI system integration 600B starts in step 609, when the identified parameters from previous steps are deployed in the AI model. In step 610, the data in the AI model is disturbed per teams in the organization. In step 611, the interaction with the AI system for ethical and inclusive results is carried out, wherein the AI outputs are audited for compliance which will be described in greater details below.

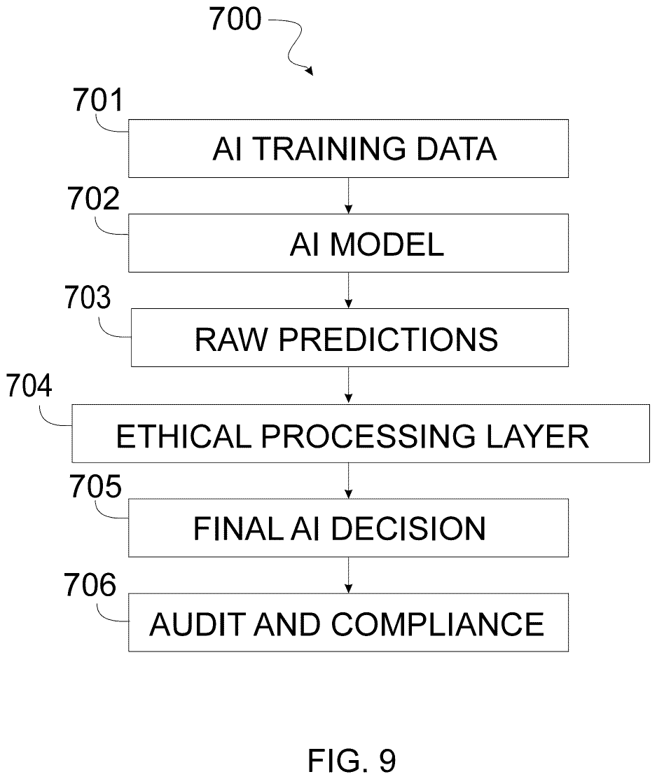

FIG. 9 is a flow diagram illustrating the AI workflow and ethical processing layer according to an embodiment of the present invention. Referring now to FIG. 9, the ethical processing layer 700 provides a structured workflow that integrates ethical governance into AI model decision-making. This architecture ensures that AI-generated outputs are ethically reviewed, modified if necessary, and monitored for compliance with fairness, transparency, and accountability requirements. In step 701, AI training data is sourced from the workshop (600A; FIG. 8), which is stored in an AI training data repository or data storage, in structured and unstructured forms. The human-centered workshop process previously described ensures the AI training data is free of biases, and represents a diverse ethically curated dataset for all stakeholders. The process allows, before the AI model is deployed, a reduction of biased primary outputs, leading to fewer real-time violations flagged by the ethical processing layer in future steps.

Next, in step 702, the AI training data is fed to the AI model, via the AI training data repository, a machine learning system that makes decisions based on entered prompts. From the AI training data, raw predictions 703 or outputs are provided, which are passed to the ethical processing layer in 704, which allows integration with the AI system to ensure the outputs are filtered and refined under the ethical parameters determined in the workshop. Next, in step 705, after the ethical processing layer, the final AI decision is validated and approved for implementation, which ensures the AI decision that is unbiased, transparent, and ethically aligned. Finally, in step 706, in real-time the AI decisions in outputs are stored in an output log or database enabling auditing and compliance to ensure the AI systems adhere to evolving ethical standards, legal requirements, and remain transparent, unbiased, and ethically aligned. If needed, updates are made and fed back to the AI training data for improvements. In one embodiment, the output log is stored in a tamper-resistant or tamper-evident database.

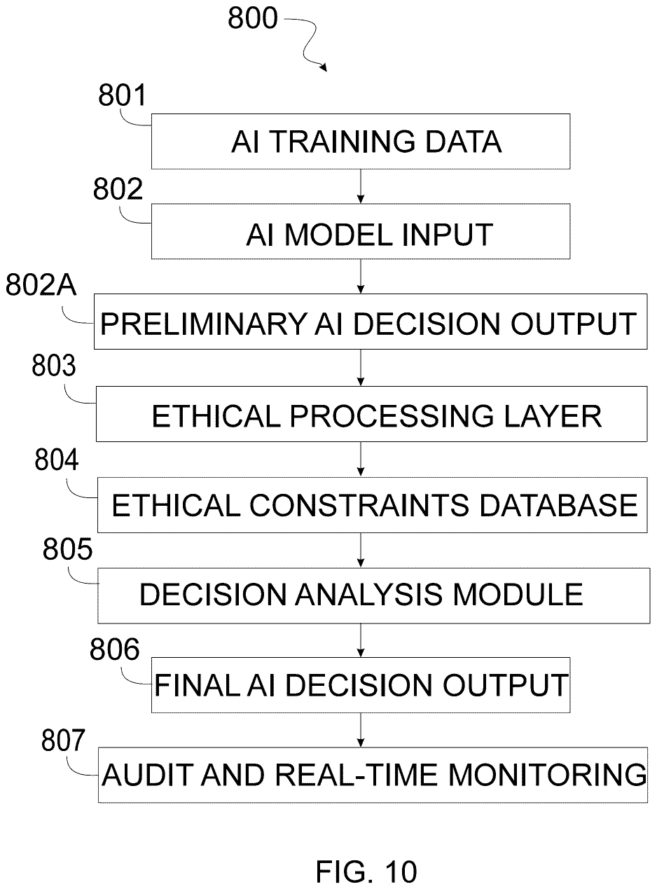

FIG. 10 is a flow diagram illustrating the ethical AI decision making pipeline according to an embodiment of the present invention. Referring now to FIG. 10, the expanded AI decision making pipeline is illustrated. In this embodiment, the AI training data 801 may lack the ethical processing of the workshop previously described, and the systems and pipeline illustrates how the AI system is improved. More specifically, an initial AI training data is provided, which may be considered a base AI system or machine learning system that is enabled to make decisions based on the AI model's training data, algorithms, and learned patterns but may contain biases, lack of fairness, or insufficient transparency. In step 802, the AI model is inputted with prompts and problems, in which the AI model generates a preliminary decision 802A. After the AI model generates a preliminary decision, in step 803, it is routed to the ethical processing layer, which implements logic for comparing that preliminary decision against one or more constraints in the ethical constraints database 804. In some embodiments, this layer includes a decision analysis module 805 that calculates one or more metrics (e.g., fairness, bias, risk) specific to each decision output.

Advantageously, in real-time the AI system, via the ethical processing layer, is configured to dynamically and ethically apply weighted calculations from constraints and parameters developed from the human-centered workshop (600A; FIG. 8) via an ethical constraints database 804 to the inputted with prompts and problems. Regarding the decision analysis module, the AI outputs are evaluated and scored within this module. If any metric exceeds a predefined threshold from the ethical constraints database, the decision analysis module triggers the ethical review layer. The AI outputs are reviewed for ethical compliance via an ethical review sub-routine, violations are flagged and the AI prompts, ethical constraints database are updated to provide a final AI decision output 806 that is unbiased, transparent, and ethically aligned. For example, the ethical processing layer fetches relevant constraint definitions from the ethical constraints database, uses them to derive numerical scores, and checks these scores against permissible thresholds. If any metric violates a constraint (e.g., the system detects a 10% skew where a 5% maximum is allowed), the ethical processing layer automatically flags the decision for alteration or rejection. In some embodiments, if a decision is flagged, the ethical processing layer modifies the AI output by adjusting internal weighting factors or by substituting an alternative recommendation that meets the constraint parameters. Finally, in step 807, in real time the AI decisions may be audited and monitored for compliance, by an audit and compliance subsystem. In one embodiment, following the modification or validation of the preliminary decision, the system produces the final AI decision output, which at the same time, the audit and compliance subsystem creates or updates an audit record capturing at least: the initial input data, the raw output of the AI model, the set of constraints checked, the final determination or modification, and the time stamp and user/system identifiers. In some embodiments, the audit record is stored in a secure database. In another embodiment, the audit record is stored using cryptographic hashes or a blockchain-based log, ensuring subsequent review or compliance checks. The goal is to provide an auditing mechanism that provides technological transparency by enabling authorized stakeholders to trace and reconstruct the AI's decision making process. Advantageously, this process may fulfill accountability requirements if used in a regulated sector. For example, banking, healthcare, utilities, transportation, legal, and manufacturing.

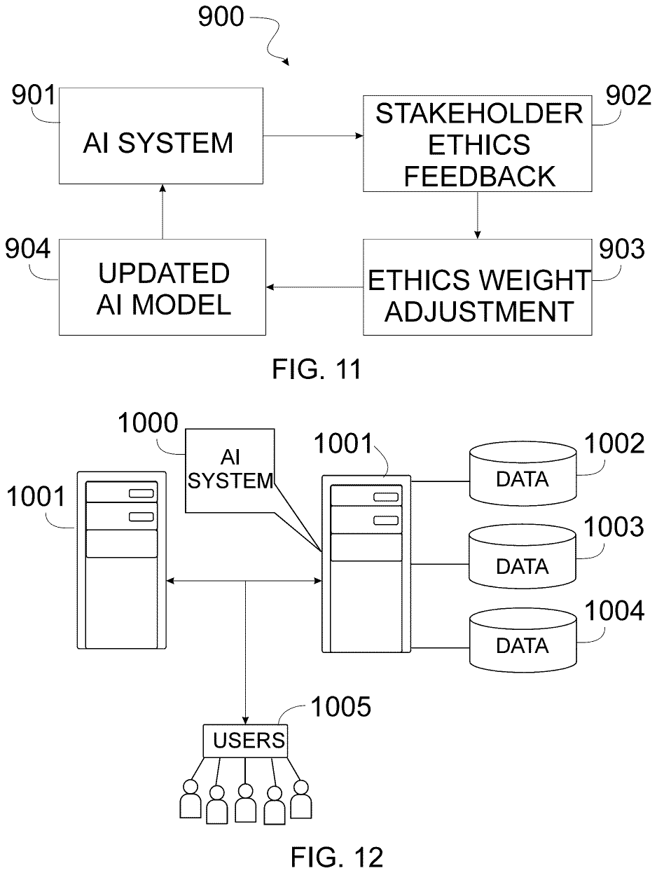

FIG. 11 illustrates an AI ethics feedback loop for the ethical artificial intelligence decision making system according to an embodiment of the present invention. Referring now to FIG. 11, it is critical that the system has an AI ethics feedback loop 900 implemented in the system to ensure the AI model adapts over time to influence future AI decisions providing an adaptive mechanism not based on static ethical rules. 901 represents the AI system before feedback or modification, which may be considered the AI system at any given time. Next, stakeholders provide ethics feedback 902 based on real-world performance, which is provided via an ethics weight adjustment or weighted scoring model 903, which is then updated and integrated into the AI model 401 providing a new AI system. This process is continuous, enabling the AI system to refine ethical constraints dynamically, ensuring future AI decisions reflect evolving ethical standards.

In other embodiments, the AI ethics feedback loop may include a feedback loop that updates or retrains the AI model based on aggregated audit data and stakeholder input. For instance, after each batch of decisions, the system may prompt designated reviewers, such as compliance officers, to rate the ethical acceptability of the AI outputs. If consistent patterns of unethical or biased decisions are detected, the system automatically triggers a retraining process, adjusting model parameters or data weighting to minimize future violations. In some embodiments, the retraining process can occur offline. In other embodiments, the retraining process may occur in near real-time.

FIG. 12 illustrates a computerized hardware environment for the ethical AI decision making system according to an embodiment of the present invention. Referring now to FIG. 12, the AI system 1000 is configured to execute over one or more connected computerized devices 1001, each containing CPUs, GPUs, or specialized AI accelerators. The computerized devices may be locally connected over local network, cloud infrastructure, or hardwired Internet connected system. In some embodiments, client applications or dashboards allow authorized users 1005 to query the final decision outputs, review the audit logs, and provide feedback for model updates. Although the hardware environment may vary, in one embodiment, the computerized devices are connected to a training data database 1002, ethical constraints database 1003, and an audit logging database 1004.

In some embodiments, the data in any of the aforementioned databases may include numerical data, text, images, or other modalities suitable for machine learning. In some embodiments, the ethical constraints database is a structured datastore containing rules, parameters, or thresholds that define permissible decision criteria. In one embodiment, these data constraints are encoded as key-value pairs, schemas, ontologies, or other machine-readable formats. Each constraint entry can specify a dimension of ethical evaluation, e.g., fairness score, bias thresholds, transparency requirements with corresponding allowable ranges and parameters. In some embodiments, the database can be hosted locally. In other embodiments, the database is a distributed cloud environment, or partitioned across multiple nodes to ensure high availability and rapid access. In an example, the following is an exemplary constraint stored in the database: {“constraintID”: “Anti-Discrimination-Race”, “maxSkew”: 0.05, “type”: “statistical_parity”, “description”: “Prevents decisions that produce more than 5% disparity in approvals for protected groups.”}. By structuring ethical constraints in a well defined representation, the AI-system can quickly retrieve, interpret, and apply these rules to a wide range of AI use cases and prompts.

The following are non-limiting prophetic examples of the AI system in use. As an example, the AI system may be implemented within a financial institution to automate loan approvals. However, historical biases in lending data can lead to discriminatory outcomes against certain groups, e.g., unfair denial rates based on race or socioeconomic status. In this example, the system receives input data, or base training data, such as: applicant financial history, credit score, income, debt-to-income ratio. The AI system then generates a preliminary decision output, wherein the AI system calculates a loan approval likelihood score. This is reviewed automatically by the ethical processing layer, which checks for disparate impact ensuring approvals aren't biased against protected groups and compares the AI's decision making to human-approved historical workshopped decisions to detect inconsistencies. The ethical processing layer further enforces explainability rules, ensuring that loan denial reasons are clear and actionable. If necessary, the decision analysis module executes and implements decision modifications if an application is denied due to high-risk factors that disproportionately impact one group, the AI system suggests alternative creditworthiness metrics, such as, transaction patterns instead of strict credit scores. This adjusts decision thresholds to ensure ethical compliance and compliance with fair lending laws. Next, a final AI decision output is provided, wherein the loan decisions are ethically validated before being communicated to the applicant. Finally, the audit and compliance module logs all decision-making steps to allow regulators to audit AI lending practices and enable stakeholders to make real-time adjustments to the AI system using the AI ethical feedback loop. In this example, the AI system integrates adversarial fairness constraints into AI decision making, provides and implements an alternative creditworthiness modeling, reducing reliance on historically biased credit metrics while ensuring auditability and compliance monitoring, enabling regulators to trace AI decision rationales.

In a second prophetic example of the AI system in use, a healthcare AI system is tasked with patient triage decisions. The AI system receives patient data, including vitals, symptoms, and medical history as input. The AI model outputs a suggested triage level, such as critical, urgent, or routine. The ethical constraints within the database, via an earlier workshop, may include fairness criteria ensuring that minority groups are not systematically assigned lower triage levels. The AI system logs each triage decision along with ethical analysis results. If violations against the fairness threshold are identified, e.g., certain patient demographics consistently receive less urgent triage classifications without clinical justification, the system's feedback loop updates the AI model's weighting parameters to address the bias. The final triage recommendations thus continuously improve over time while maintaining a clear audit trail of every decision and modification.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

What is claimed is:

1. A computer-implemented method for ethical decision-making in an artificial intelligence (AI) system, comprising steps:
(a) receiving input data from one or more users relevant to an AI-driven decision;
(b) generating a preliminary decision output by processing the input data with a trained AI model executed by at least one processor;
(c) applying an ethical processing layer to the preliminary decision output by executing a set of programmed instructions that incorporate predefined role-specific ethical constraints from an ethical constraints database, the ethical constraints being derived from multi-level organizational ethics workshops, wherein the multi-level organizational ethics workshops comprise structured, facilitated human-centered sessions including stakeholders across multiple organizational levels and roles, and wherein the ethical constraints are traceable to a stakeholder consensus generated during the multi-level organizational ethics workshops;
(d) analyzing automatically, via the ethical processing layer, the preliminary decision against the role-specific ethical constraints in an automated and contextual manner that accounts for an organizational role of a user of the one or more users associated with the preliminary decision;
(e) modifying the preliminary decision when a violation of an ethical rule is detected;
(f) producing a modified final decision output responsive to the input data inquiry that complies with the ethical constraints, the final decision output being provided to a user or another system, wherein the method further comprises logging data comprising decision-specific ethical evaluations, applied role-based constraints, and modification outcomes describing the ethical analysis of the decision of the ethical processing layer in an audit record; and
(g) initiating a notification if the preliminary decision required modification, wherein the notification is generated responsive to the ethical processing layer modifying the preliminary decision, such that the AI system's decisions are both ethically vetted and transparently recorded in real-time.

2. The method of claim 1, wherein the ethical constraints database comprises a structured datastore of machine-readable rules and parameters defining permissible decision criteria, the structured datastore being organized to support selective retrieval of ethical rules that are applicable to a particular decision context, and wherein step (c) includes retrieving one or more relevant ethical rules from the database based on a context of the input data or the type of decision, the context including decision-specific attributes associated with the preliminary decision output, and using the retrieved rules to determine whether the preliminary decision output satisfies all applicable constraints, the retrieved, contextually relevant ethical rules are evaluated to assess compliance, thereby excluding non-applicable ethical rules from evaluation, so as to ensure that AI-driven decisions remain contextually relevant, inclusive, and ethically sound for users involved in the decision-making process.

3. The method of claim 1, further comprising a step of automatically adjusting at least one parameter of the AI model based on feedback, wherein after step (f), the system receives stakeholder feedback or an override input indicating a degree of ethical satisfaction with the decision, the stakeholder feedback being received from one or more human stakeholders associated with different organizational roles or hierarchy levels, and in response, updates the AI model's parameters or retrains the AI model using the stakeholder feedback as a supervised learning signal directed to improving compliance with the ethical constraints, to improve future decision outputs, thereby providing a feedback loop that dynamically improves the AI model's adherence to the ethical constraints over time in a manner that reflects evolving human ethical expectations and organizational values.

4. The method of claim 1, wherein step (c) includes executing a decision analysis module that computes one or more quantitative ethics metrics for the preliminary decision output, including bias measures or risk scores, the quantitative ethics metrics being evaluated in view of role-specific ethical constraints associated with an organizational hierarchy, and if any metric exceeds a predefined threshold from the ethical constraints database, the predefined threshold being derived from human-centered ethical principles and differentiated according to organizational role, the decision analysis module triggers an ethical review sub-routine that alters the preliminary decision output to generate the final decision output, the alteration comprising adjusting the ethical constraints database by modifying one or more role-specific ethical parameters stored therein such that the one or more quantitative ethics metrics are brought within acceptable limits for future AI-driven decisions in a dynamically adaptive manner.

5. The method of claim 1, further comprising a step of:
training the AI model in which training data is filtered or re-weighted based on ethical parameters prior to step (b), the ethical parameters being derived from the ethical constraints database and differentiated according to organizational roles within a multi-level organizational hierarchy; and
training the AI model on a dataset that has been processed according to the ethical constraints by identifying under-represented categories or potentially biased features in the dataset and augmenting the training data with respect to those ethical parameters, the augmentation being performed to embed human-centered ethical considerations into the model during training, thereby reducing bias in the model's predictions and enhancing compliance with the ethical constraints from the outset of model development and enabling the trained AI model to interact effectively with a downstream ethical processing layer that applies role-specific ethical constraints during operation.

6. The method of claim 1, wherein step (f), the audit record is stored in a secure, tamper-evident log, the tamper-evident log being structured to record an ethics-traceable chain of information for each decision, and includes information about the preliminary decision, the specific ethical constraint(s) that were applied, any modification made, and an identifier for the version of the ethical constraints database used for that decision, thereby facilitating later compliance verification and debugging of the AI system's decision process, such that auditors can reconstruct the ethical decision flow, determine how constraints influenced each decision, and analyze changes in ethical constraints over time.
